(19) United States
(12) Patent Application Publication
(10) Pub. No.: US 2009/0010637 A1
(43) Pub. Date: Jan. 8, 2009

(54) Adjustable mount for securing a camera, video camera, etc. to another member

(76) Inventor: Douglas D. DeWitt, Conrath, WI (US)

Correspondence Address: WILHELM LAW SERVICE, S.C., 100 W LAWRENCE ST, THIRD FLOOR, APPLETON, WI, 54911, US

(21) Appl. No.: 12/217,093

(22) Filed: Jun. 30, 2008

Related U.S. Application Data
(60) Provisional application No. 60/958,085, filed on Jul. 2, 2007.

(51) Int. Cl. G03B 17/00; A47F 7/00

(52) U.S. Cl. 396/428; 248/226.11

(57) ABSTRACT

An adjustable mount is disclosed for securing a piece of equipment 12 to another member. The adjustable mount includes a first member attachable to the other member and an elongated member secured at one end to the first member. A sphere is attached to the opposite end of the elongated member. A pair of plates is aligned parallel to one another and is spaced apart by a set distance. Each of the pair of plates has an aperture formed therein which is sized to mate with a portion of the sphere to enable the pair of plates to rotate, pivot and/or swivel on the sphere. The adjustable mount further includes a support structure secured to the pair of plates which is capable of having a piece of equipment 12 attached thereto. Lastly, the adjustable mount includes an adjustment mechanism capable of changing the set distance between the pair of plates.

### CROSS REFERENCE TO RELATED APPLICATION

This patent application is a regular patent application claiming priority to U.S. Provisional Patent Application Ser. No. 60/958,085, filed Jul. 2, 2007.

### FIELD OF THE INVENTION

This invention relates to an adjustable mount for securing a piece of equipment, such as a camera, a video camera, etc., to another member, such as a tree or post. More specifically, this invention relates to an adjustable mount for securing a camera to a tree, deadfall, stump, etc. outdoors so that photos can be taken of wildlife, such as deer, bear, turkeys, etc.

### BACKGROUND OF THE INVENTION

Today, many hunters and outdoor enthusiasts are using cameras, video cameras, digital cameras, etc. to photograph wildlife and/or to find out what trails or paths their potential game are using. For example, a whitetail deer hunter can attach a camera to a tree located adjacent to a trail or path and record if any deer are using the trail or path and at what time during the day or night. A photo cell in the camera will detect the movement of any animal and will trigger the camera to take a picture of the animal. The camera also records the date and time the photo was taken. The hunter then views the photos to see if any deer traveled down the path or trail, if the deer was a buck, if the buck had a large set of antlers, etc. If a big buck is using the trail or path, the hunter would then set up his or her tree stand adjacent to the trail or path in the hope of getting a shot at the deer during archery or gun season.

Such outdoor cameras are now being sold by many of the sporting good stores. These outdoor cameras can be camouflaged or painted to blend in with the natural surrounding. One problem that currently exists with mounting such cameras is that most of the cameras are designed to be strapped to the trunk of a tree. However, if the tree to which the camera is to be secured is not in the right location relative to the trail or path, the camera may not be at the most advantageous angle to take pictures of animals walking down the trail or path. Many times, there is a need to position the camera away from the trunk of the tree and/or to angle the camera to view a larger section of the trail or path.

There are a number of camera mounts being sold today which are designed to move the camera out away from the trunk of the tree. However, some of these mounts are limited as to their adjustability and many are relatively expensive. Some can only hold the camera in a single fixed position, other mounts have a single plane of rotation, and still other mounts can rotate but do not have the ability to pivot up and down or sideways. Another drawback is that some mounts are designed such that only one style or brand of camera can be attached to them. This means that a person having a different style or brand of camera cannot use such a mount.

Now, an adjustable mount has been invented for securing a camera to a tree which can accommodate most styles and brands of cameras, can rotate and pivot or swivel in multiple planes, is inexpensive to manufacture and is easy to set up in the woods.

### SUMMARY OF THE INVENTION

Briefly, this invention relates to an adjustable mount for securing a piece of equipment, such as a camera, video camera, a sound recorder, etc., to an upstanding member, such as a tree, post or stump. The adjustable mount includes a first member attachable to the upstanding member and an elongated member, having a first end and a second end, with the first end secured to the first member. The adjustable mount also includes a sphere attached to the second end of the elongated member. A pair of plates is aligned parallel to one another and each is spaced apart by a set distance. Each of the pair of plates has an aperture formed therethrough which is sized to mate with a portion of the sphere. The pair of plates is capable of rotating, pivoting and/or swiveling on the sphere. The adjustable mount further includes a support structure secured to the pair of plates. The support structure has at least one attachment mechanism to which the piece of equipment can be attached. Optionally, a protective cage can be attached to the support structure to enclose the entire piece of equipment and protect it from being destroyed by a wild animal, such as a bear. Lastly, the adjustable mount includes an adjustment mechanism positioned between the pair of plates which is capable of changing the set distance. The adjustment mechanism is capable of rotating in a first direction to lock the pair of plates to the sphere and can rotate in an opposite direction to unlock the pair of plates from the sphere.

The general object of this invention is to provide an adjustable mount for securing a piece of equipment to a stationary object, such as a tree, post or stump. A more specific object of this invention is to provide an adjustable mount for securing a camera, video camera or other recording device to an upstanding object so as to record and photograph wild game in their natural surroundings.

Another object of this invention is to provide an adjustable mount for securing a recording device to a live tree, a dead tree, a deadfall, a stump, a post or any other member or object.

A further object of this invention is to provide an adjustable mount for supporting a piece of equipment, such as a camera, which is relatively easy and inexpensive to manufacture.

Still another object of this invention is to provide an adjustable mount for supporting a piece of equipment, such as a camera, which is easy to adjust and manipulate in the outdoors.

Still further, an object of this invention is to provide an adjustable mount for supporting a piece of equipment, such as a camera, which will not rust or corrode.

Other objects and advantageous of the present invention will become more apparent to those skilled in the art in view of the following description and the accompanying drawings.

### BRIEF DESCRIPTION OF THE DRAWINGS

FIG. 1 is a perspective view of an adjustable mount for securing a piece of equipment to another member or object.

FIG. 2 is a perspective view of the adjustable mount shown in FIG. 1 holding a camera to a tree that has been blown over and is aligned at an angle to the ground.

FIG. 3 is a plane view of a threaded fastener for securing the first member to another member, such as a tree.

FIG. 4 is a perspective view of a portion of a tree trunk having the first member held secured thereto by a pair of straps.

FIG. 5 is a perspective view of the pair of plates secured to a metal grid.

FIG. 6 is an assembly view showing a threaded adjustment mechanism joining a pair of plates together wherein as the threaded adjustment mechanism is rotated in one direction, the apertures are locked to the sphere and when the threaded adjustment mechanism is rotated in an opposite direction, the apertures are unlocked from the sphere.

FIG. 7 is a top view of an aperture having a serrated inner periphery.

FIG. 8 is a plane view of the back surface of a bracket which can be removably attached to a pair of plates.

FIG. 9 is a perspective view of the adjustable mount having the bracket shown in FIG. 8 and having a screw that can be used to secure a piece of equipment, such as a camera, not shown, to the adjustable mount via the bracket.

FIG. 10 is a plane view of a bolt and attachable wing nut used to secure a piece of equipment, such as a camera, to the bracket shown in FIG. 8.

FIG. 11 is a top view of the threaded adjustment mechanism taken along line 11-11 of FIG. 6.

FIG. 12 is a perspective view of a U-shaped clip shown in FIG. 6 into which a screw can be threaded.

FIG. 13 is a perspective view of a protective cage that can be removably attached to the support structure shown in FIGS. 1, 5 and 9.

FIG. 14 is a perspective view of the adjustable mount holding a camera to an upstanding tree and showing the protective cage attached.

FIG. 15 is a perspective view of the adjustable mount holding a video camera to an upstanding tree.

### DETAILED DESCRIPTION OF THE INVENTION

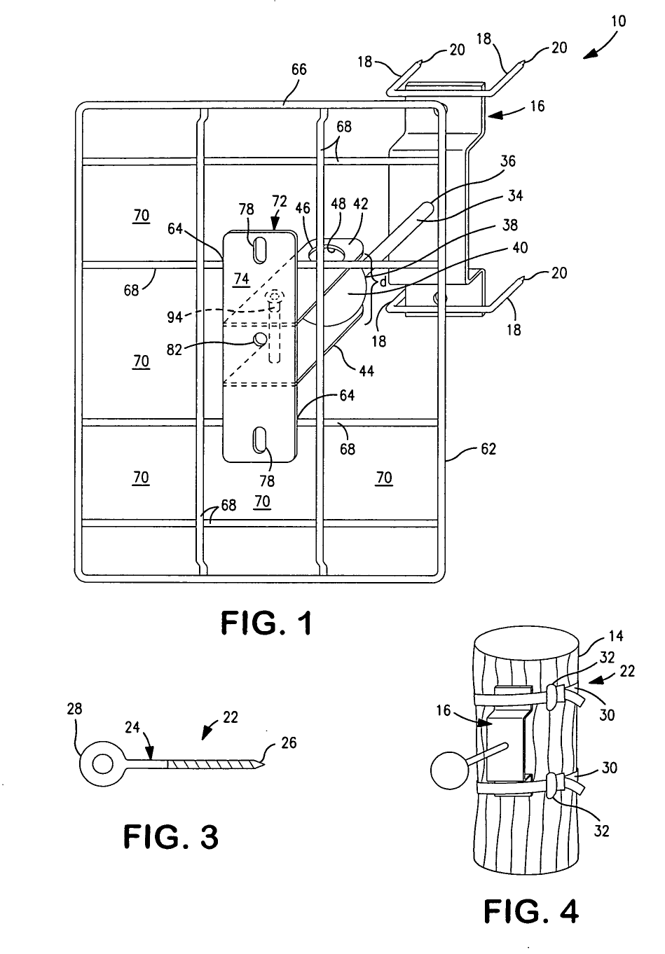

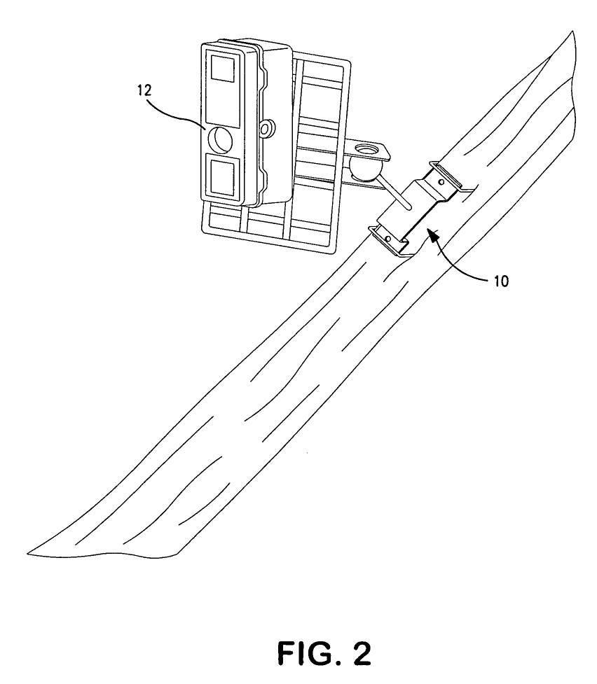

Referring to FIGS. 1 and 2, an adjustable mount 10 is shown for securing a piece of equipment 12 in a desired position relative to another member or object 14. The piece of equipment 12 can be a camera, a camera with or without a flash unit, a 35 millimeter camera, an outdoor camera, an outdoor game camera, a portable camera, an INSTAMATIC® camera, a video camera, a film camera, a digital camera, a spotting scope, an optical device, a surveillance mechanism, a piece of photographic equipment, a surveying instrument, an engineering instrument, a motion detector, a sound recorder, a video projector, a video recorder, etc. Almost any type of equipment or device 12 can be secured to the adjustable mount 10.

The adjustable mount 10 can be removably secured or attached to another member or object 14. The other member or object 14 can be a stationary member, a movable member, an upstanding member, a member aligned at an angle to the ground, a member aligned adjacent to the ground, a natural member or a manmade member. By “stationary” it is meant a fixed member unable to change location; by “moveable” it is meant a member that can be moved; and by “upstanding” it is meant a member having a vertical vector. For example, the member or object 14 can be a live tree, a dead tree, a post, a fence post, a telephone pole, a stump, a dead fall tree, a tree that has been partially blown over and is aligned at an angle to the ground, etc. In addition, the other member or object 14 can be secured to a metal fence post, a T-post, a steel tube, etc. that can be affixed or pounded into the ground at any desired location. Furthermore, the adjustable mount 10 can be affixed to a member or object 14 such as a two legged object, a tripod, a stool, a four legged object, etc. Typically, the adjustable mount 10 is intended to be used outdoors by animal lovers, bird watchers, photographers, small and large game hunters, waterfowl watchers and hunters, outdoor enthusiasts, etc. However, the adjustable mount 10 can also be used indoors to mount various kinds of equipment, including but not limited to: lighting equipment, sound equipment such as for a band, surveillance equipment, video projectors, etc.

The adjustable mount 10 can be constructed out of various materials, including but not limited to: metal, steel, a metal alloy, aluminum, titanium, magnesium, tin, zinc, plastic, a thermoplastic, a plastic composite, or any combination thereof. These as well as other materials known to those skilled in the art can be utilized. The adjustable mount 10, especially if it is to be used outdoors, should be constructed of a material that can stand up to the elements. Desirably, the adjustable mount 10 will be treated, coated, painted, baked or be encased in a rust resistant material, such as an outdoor paint, an enamel paint, a rust resistant paint, a ceramic coating, a powder coating, or be encased in a weather resistant plastic. Most desirably, the adjustable mount 10 will be formed from an environmentally resistant material or be rust proof.

Still referring to FIG. 1, the adjustable mount 10 includes a first member 16 depicted as being a rectangular shaped member having a stepped or U-shaped side profile. However, any desired shape or configuration can be used for the first member 16. The first member 16 also has at least two elongated and spaced apart legs 20 projecting outward therefrom. In FIG. 1, four legs 18 are present with each leg 18 situated approximately at a corner of the rectangular first member 16. The legs 18 are aligned approximately perpendicular to the first member 16. Each of the legs 18 can have a length of at least about 1 inch. Desirably, each of the legs 18 has a length of from between about 1 inch to about 3 inches. Each of the legs 18 has a sharp distal end 20 which can facilitate each leg 18 engaging with the bark on a tree. Some trees, like a mature oak tree, have deep furrows in their bark which surround the trunk and the sharp distal ends 20 of the elongated legs 18 permit the adjustable mount 10 to be easily secured to these particular trees.

Referring to FIGS. 3 and 4, the adjustable mount 10 also has at least one fastener 22 sized to secure the first member 16 to the other member or object 14. In FIG. 3, the fastener 22 is depicted as a screw 24 having a first end 26 machined into a sharp point and an opposite, second end 28 having an enlarged head. The enlarged head formed at the second end 28 will assist in allowing a person to easily screw the screw 24 into the trunk of a tree 14. In FIG. 4, the fastener 22 is depicted as a pair of straps 30 each having an adjustable mechanism 32. One or two straps 30 can be utilized. The straps 30 encircle the circumference of the tree 14 or other object and engage the first member 16. The straps 30 can be pulled snug to hold the first member 16 secure to the tree 14. It should be understood by those skilled in the art that the first member 16 can be configured to include one or more slots, grooves, passageways, or some other kind of structure through which one or more straps 30 can pass so as to ensure that the first member 16 does not separate from the strap(s) 30. It should be further understood that as the fastener 22 is secured to the member or object 14, i.e. a tree, the sharp distal ends 20 of the elongated legs 18 will contact and may even penetrate into the bark or outer surface of the tree 14.

Referring again to FIG. 1, the adjustable mount 10 further includes an elongated member 34, in the shape of a stem. The elongated member 34 has a first end 36 and a spaced apart second end 38. The elongated member 34 can have a cross-section that is round, circular, square, rectangular, pentagon, hexagon, oval or any other geometrical shape one desires. The elongated member 34 should have a length of from between about 1 inch to about 12 inches. Desirably, the elongated member 34 should have a length of from between about 3 inches to about 9 inches. More desirably, the elongated member 34 should have a length of from between about 4 inch to about 8 inches. Most desirably, the elongated member 34 should have a length of at least 5 inches so as to position the remainder of the adjustable mount 10 away from the trunk of the tree 14. The first end 36 of the elongated member 34 is secured to the first member 16. Desirably, the first end 36 of the elongated member 34 is secured to the center or middle of the first member 16. The second end 38 of the elongated member 34 is secured or attached to a sphere 40. By “sphere” it is meant a three dimensional surface all points of which are equidistant from a fixed point. Desirably, the sphere 40 is a round ball formed from a hard or semi-hard material. For example, the sphere 40 can be formed from a material, such as hard rubber, neoprene, etc. A semi-hard or hard surface is resistant to being easily deformed or altered in appearance. In some applications, the sphere 40 can be constructed to have an outer periphery that has a relatively low coefficient of friction.

Referring to FIG. 6, the sphere 40 has a diameter d which can vary in dimension. Desirably, the diameter d should be at least 1 inch. More desirably, the diameter d of the sphere 40 should be from between about 1 inch to about 6 inches. Even more desirably, the diameter d of the sphere 40 should be from between about 1.25 inches to about 3 inches. The diameter d of the sphere 40 can be constructed to be larger than 6 inches, if desired.

Referring to FIGS. 1, 5 and 6, the adjustable mount 10 also includes a pair of plates 42 and 44 aligned approximately parallel to one another. The pair of plates 42 and 44 is spaced apart from one another by a set distance d₁. The set distance d₁ can vary as will be explained shortly. Each of the pair of plates 42 and 44 has an aperture 46 formed therethrough which is sized to mate with a portion of the sphere 40. By “mate” it is meant to join up and interact with one another. It should be understood that alternative structures for the apertures 46 can also be utilized. For example, a closed, semi-spherical cavity could be formed in each of the pair of plates 42 and 44 which could be sized to mate with the sphere 40. In this example, each of the pair of plates 42 and 44 could have a greater thickness and each of the cavities would be capable of performing the same function as each of the apertures 46. When the apertures 46 are in contact with the sphere 40, they are coaxially aligned with one another and share the same centerline Y-Y, see FIG. 6. Each of the apertures 46 has an inner circumference 48 which can be machined to have a relatively sharp edge so as to grip or engage with the outer periphery of the sphere 40. Optionally, the inner circumference 48 can be beveled so as to more fully engage with the outer periphery of the sphere 40. By “beveled” it is meant an angle of inclination of a line or surface that meets another at any angle except 90 degrees.

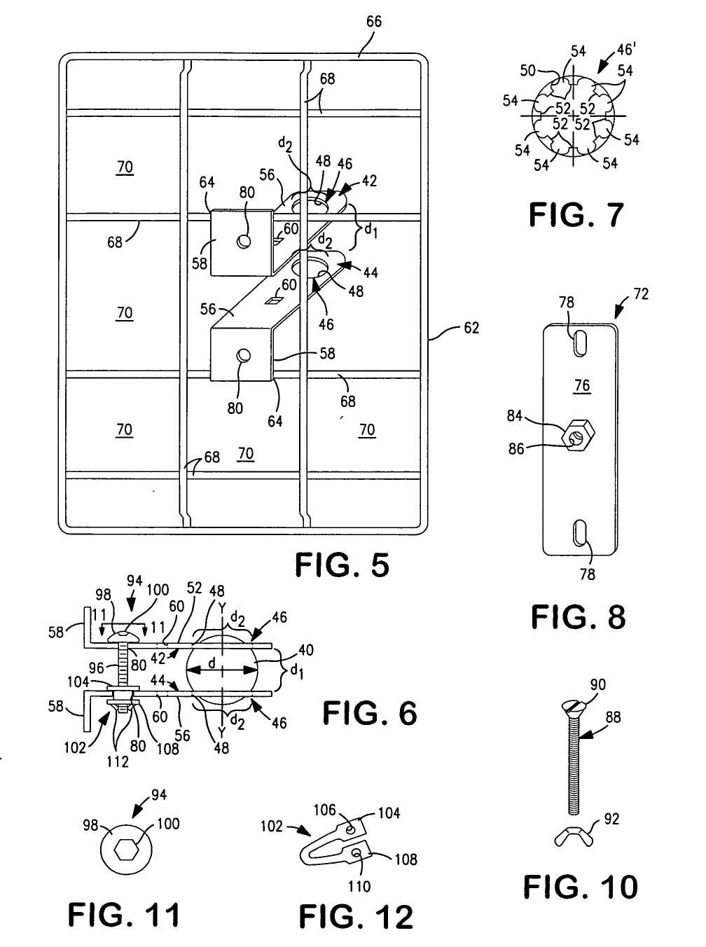

As best depicted in FIGS. 5 and 6, each of the apertures 46 has a diameter d₂ which is smaller than the diameter d₁ of the sphere 40. For example, the diameter d₁ of the sphere 40 can be about 1.25 inches and the diameter d₂ of each of the apertures 46 can be about 1 inch. Other dimensions can be selected as well. This difference in diameter allows the apertures 46 to mate with the periphery of the sphere 40 and allow the pair of plates 42 and 44 to rotate, pivot and/or swivel on the sphere 40. Desirably, the pair of plates 42 and 44 will be able to rotate and pivot on the sphere 40. More desirably, the pair of plates 42 and 44 will be able to rotate, pivot and swivel on the sphere 40.

Turning to FIG. 7, an alternative embodiment of an aperture 46′ is shown having a serrated inner periphery 50. By “serrated” it is meant having or forming a continuous or intermittent line or surface of small sharp projections which can be constructed of various shapes or configurations. The serrated inner periphery 50 is constructed of, or contains, a plurality of tooth-like projections 52 each separated by a notch 54. However, other shaped tooth-like projections can also be utilized. For example, one could form sharper, triangular shaped teeth, similar to those normally formed on a saw blade, if desired.

The serrated inner periphery 50 is designed to mate with a portion of the sphere 40. The serrated inner periphery 50 is capable of providing a better grip or is capable of more fully engaging with the outer periphery of the sphere 40 than would a normal circular aperture 46. When a serrated inner periphery 50 is utilized, at least three tooth-like projections 52 should be formed. Desirably, the serrated inner periphery 50 will contain a plurality of tooth-like projections 52. More desirably, the serrated inner periphery 50 will contain from 3 to 100 tooth-like projections 52. More desirably, the serrated inner periphery 50 will contain from 4 to 60 tooth-like projections 52. As one skilled in the art will recognize, the number of projections 52 can increase as the diameter d₂ of each aperture 46′ increases.

Still referring to FIG. 7, the aperture 46′ is shown containing eight projections 52 each separated by a notch 54. The eight projections 52 are arranged approximately 45 degrees apart. As fewer projections 52 are utilized, the arrangement of the projections 52 will be spaced at a greater number of degrees apart. Likewise, as more than eight projections 52 are used, the arrangement of the projections 52 will be spaced at a lesser number of degrees apart.

Referring again to FIGS. 1, 5 and 6, each of the pair of plates 42 and 44 is depicted as having an L-shaped profile although other profiles can also be utilized. For example, each of the pair of plates 42 and 44 could be a flat, planar member. As depicted, the L-shaped profile includes a first section 56 and a second section 58. The first section 56 is longer in length than the second section 58, although both sections 56 and 58 could be constructed to the same dimensions, if desired. Alternatively, the second section 58 could be made longer than the first section 56. The first section 56 has the aperture 46 or 46′ formed therein as well as another aperture 60. The aperture 60 is spaced apart from the aperture 46 or 46′. Each of the apertures 60 is depicted as being square holes but they could be circular or of any other desired shape. The apertures 60 should be sized to allow a bolt or screw of a given diameter to easily pass therethrough while the head of the bolt or screw is prevented from passing through the apertures 60. The second section 58 of the L-shaped profile is secured to a support structure 62 by an attachment 64, see FIG. 5. The attachment 64 can be a mechanical or chemical connection, and includes, but is not limited to: a weld, a bond, an adhesive bond, a mechanical connector such as a metal bracket secured by a bolt and nut, etc. Those skilled in the art will know of various ways for securing the pair of plates 42 and 44 to the support structure 62. A weld works best when the pair of plates 42 and 44 is formed from a metal.

In FIGS. 1 and 5, the support structure 62 is depicted as a grid. By “grid” it is meant a framework of crisscrossed or parallel bars, a grating or mesh. The support structure 62 can be formed of various materials. Desirably, the support structure 62 is formed from metal wire having a diameter of at least 0.06 inches, desirably a diameter of at least 0.08 inches, and more desirably, a diameter of at least 0.125 inches or greater. The support structure 62 has an outer periphery 66 with a plurality of cross members 68 secured thereto to form a plurality of open spaces or holes 70. The cross members 68 can be arranged perpendicular, parallel, or at an angle to the outer periphery 66 as well as to one another. The open spaces or holes 70 can vary in size and configuration. The outer periphery 66, the cross members 68 and the open spaces or holes 70 are designed to cooperate together to allow a piece of equipment 12 to be attached or secured thereto. For example, one or more straps can be used to secure a piece of equipment 12, such as a camera or a video camera, to the support structure 62. Alternatively, one or more mechanical connectors, not shown, such as clips, brackets, bolts and nuts, screws, etc. can be used to secure a piece of equipment 12 to the support structure 62.

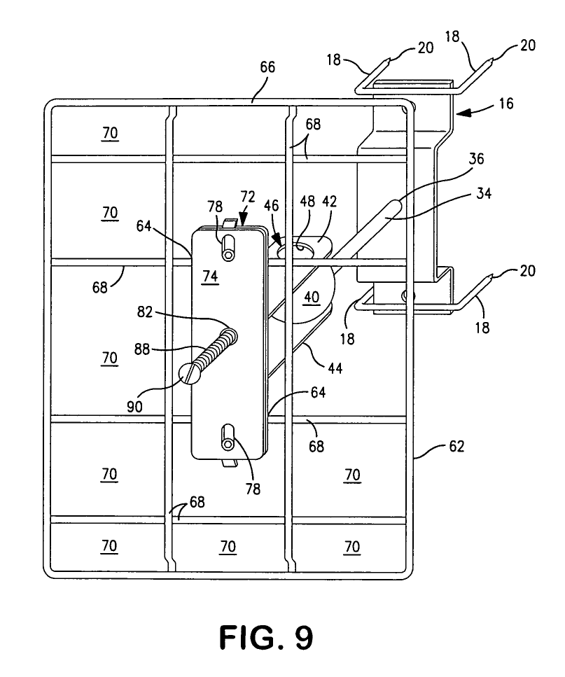

Referring now to FIGS. 1, 8 and 9, a bracket 72 is shown having a first surface 74 and an oppositely aligned second surface 76. The bracket 72 is optional and if not present, the piece of equipment 12 can be secured directly to the support structure 62. The first or front surface 74 faces the front of the support structure 62 and away from the sphere 40. The second or back surface 76 faces towards the sphere 40, see FIG. 8. The bracket 72 is depicted as a rectangular member although it could have almost any desired geometrical configuration. The bracket 72 can be formed of various materials but typically is formed from a metal. The bracket 72 contains a pair of elongated, spaced apart slots 78 formed through the thickness of the bracket 72. The slots 78 are spaced and sized to line up with a pair of apertures 80, one of which is formed in each of the second sections 58 of each L-shaped profile plate 42 and 44, see FIG. 9. A screw and nut, not shown, can be inserted through each of the slots 78 and the corresponding aligned aperture 80 to secure the bracket 72 to the pair of plates 42 and 44. The bracket 72 also has an aperture 82, see FIG. 1, formed therethrough and located approximate the longitudinal and transverse midpoint of the bracket 72. The aperture 82 is situated vertically between the slots 78. Optionally, the aperture 82 can be threaded, if desired. A nut 84 having a threaded bore 86 formed therethrough is secured to the second or back surface 76 of the bracket 72. The nut 84 can be secured in place by a weld or any other means known to those skilled in the art.

Referring to FIGS. 9 and 10, the threaded bore 86 formed in the nut 84 is aligned with the aperture 82 formed in the bracket 72. The threaded bore 86 is sized to receive a screw 88. The screw 88, see FIG. 10, can be an elongated member having a length of at least 1 inch or more. Desirably, the screw 88 will have a length of from between about 1 inch to about 4 inches. More desirably, the screw 88 will have a length of from between about 1.5 inches to about 3 inches. Other lengths can also be used for the screw 88, if needed. The screw 88 has an enlarged head 90 and is designed to secure a piece of equipment 12, such as a camera, a video camera, etc. to the support structure 62 via the bracket 72. An optional wing nut 92, see FIG. 10, can be threaded onto the free end of the screw 88 and can abut against the nut 84 if a more secure attachment is required. Normally, the wing nut 92 is not needed.

Referring now to FIGS. 1, 6, 11 and 12, the adjustable mount 10 further includes an adjustment mechanism 94 positioned between the pair of plates 42 and 44. The adjustment mechanism 94 is capable of changing the set distance d₁ located between the pair of plates 42 and 44. The adjustment mechanism 94 includes a screw 96 having an enlarged head 98. The enlarged head 98 has a hexagonal opening 100 formed therein. A standard Allen wrench, not shown, can be inserted into the hexagonal opening 100 to rotate the screw 96 clockwise and/or counterclockwise. The screw 96 passes through the apertures 80 formed in the pair of plates 42 and 44 such that the enlarged head 98 contacts one of the pair of plates 42 or 44. A U-shaped clip 102, see FIG. 12, having a first end 104 with an aperture 106 formed therethrough and a second end 108 with an aperture 110 formed therethrough, is attached to the other plate, 42 or 44, and the screw 96 passes through the apertures 106 and 110. The U-shaped clip 102 also includes a pair of oppositely aligned tangs 112, see FIG. 6, located on the outside surface of the second end 108. By “tangs” it is meant a sharp point, tongue or prong. The tangs 112 are arranged parallel and facing one another and provide a means to hold and secure the screw 96 to the clip 102. Other mechanical attachment devices known to those skilled in the art can be used in place of the screw 96 and/or the clip 102.

As one rotates the screw 96 in a first direction, the screw 96 will advance through the apertures 106 and 110 formed in the clip 102 and cause the pair of plates 42 and 44 to move closer together. In short, the set distance d₁ will decrease. This action will cause the apertures formed in the pair of plates 42 and 44 to engage with the outer periphery of the sphere 40. Further tightening of the screw 96 will lock the pair of plates 42 and 44 to the sphere 40. The direction of rotation of the screw 96 in order to tighten it relative to the clip 102 will be determined by the threads formed on the screw 96. Either left handed thread or right handed threads can be machined into the screw 96. With a right handed thread, turning or rotating the screw 96 clockwise will cause it to advance into the clip 102 and be tightened. By rotating the screw 96 in an opposite direction, one can unlock the pair of plates 42 and 44 from the sphere 40. As the screw 96 is loosened, the adjustment mechanism 94 will allow the support structure 62 to rotate, pivot and/or swivel relative to the sphere 40. By “rotate” it is meant that the support structure 62 can turn on an axis or center, by “pivot” it is meant that the support structure 62 can rotate or swing, and by “swivel” it is meant that the support structure 62 can freely turn relative to the sphere.

The pair of plates 42 and 44 can rotate in a first plane over a range of from about 1 degree to about 200 degrees. The first plane is aligned relative to the sphere 40. The pair of plates 42 and 44 can also pivot in a second plane which is aligned at an acute angle to the first plane. By an “acute angle” it is meant an angle of less than 90 degrees. The pair of plates 42 and 44 can pivot in a second plane over a range of from about 1 degree to about 60 degrees. Desirably, the pair of plates 42 and 44 can pivot 360 degrees on the sphere 40 in one plane and can rotate at least 180 degrees in a second plane. More desirably, the pair of plates 42 and 44 can swivel on the sphere 40 through various angles so that the adjustable mount 10 can position a piece of equipment 12 at the most advantageous angles relative to a trail or path.

Returning to FIG. 9, one will notice that the support structure 62 is quite large. Optimally, the outer periphery 66 of the support structure 62 will be larger than the piece of equipment 12, i.e. camera, which is secured to it. In addition, it should be understood that at least the first member 16, the elongated member or stem 34, the pair of plates 42 and 44, and the support structure 62 should be painted, treated or powder coated to prevent rusting. The sphere 40 does not have to be treated, painted or powder coated if it is constructed of hard rubber or neoprene.

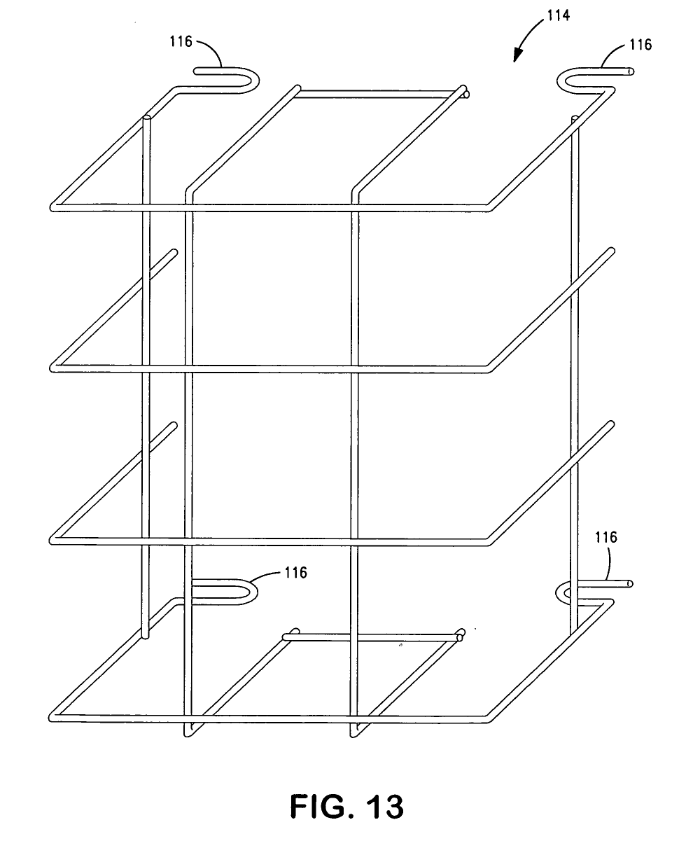

Referring now to FIG. 13, a protective cage 114 is shown which can be removably attached to the support structure 62. The protective cage 114 has a rectangular, box like configuration. However, it should be understood that almost any geometrical configuration could be used. The protective cage 114 has one or more attachment members 116 that can be easily snapped or attached onto the support structure 62. The exact size, shape and configuration of the attachment members 116 can vary as is well known to those skilled in the art. Desirably, the protective cage 114 is formed from metal or heavy gage metal wire and is strong enough to resist being broken when hit or swatted by a bear's paw. The protective cage 114 should be of sufficient size and shape to completely enclose and protect the piece of equipment 12, i.e. a camera. Desirably, the piece of equipment 12, i.e. a camera, has an outer periphery, and the support structure 62 and the protective cage 114 has an outer periphery which is larger than the outer periphery of the camera. This size dimension will permit the protective cage 114 to completely enclose and protect the camera.

The protective cage 114 is an optional accessory that is normally not needed except when photographing or filming a large wild animal such as a black bear, brown bear, Kodiak bear, a mountain lion, etc.

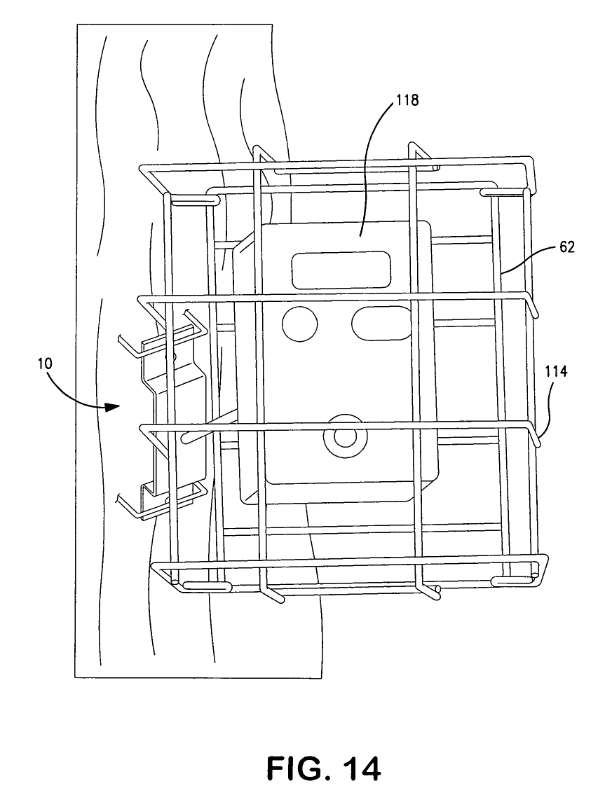

Turning now to FIG. 14, the adjustable mount 10 is shown attached to an upstanding tree 14. The adjustable mount 10 has a protective cage 114 attached to the support structure 62. Together the support structure 62 and the protective cage 114 enclose and protect a camera 118. The protective cage 114 does not interfere with the operation or with the lens of the camera 118. In FIG. 14, the camera 118 as well as the adjustable mount 10 can be painted or camouflaged to blend it with the surrounding vegetation. By “camouflaged” it is meant a method or result of concealing an object from an animal by making the object appear to be part of the natural surroundings.

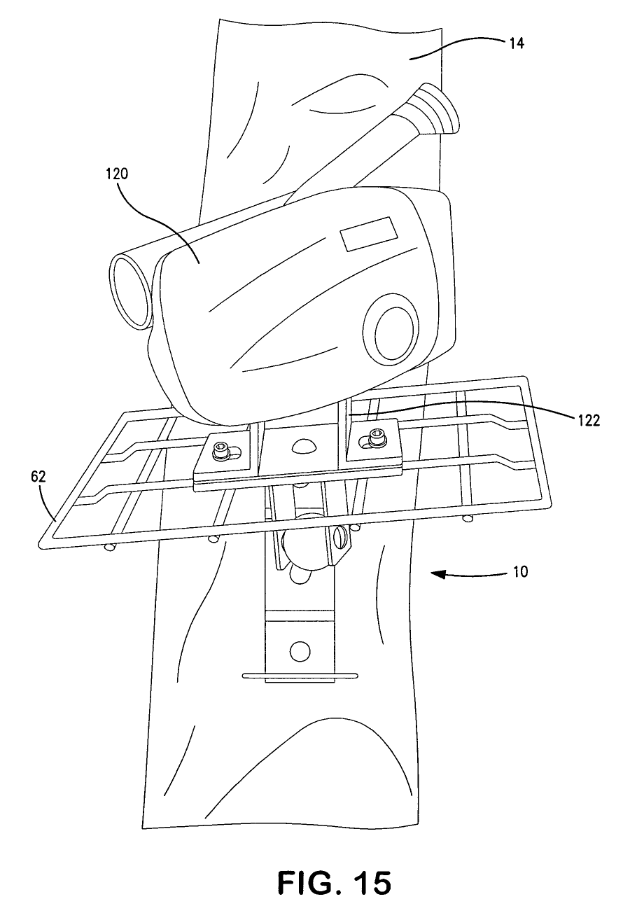

Referring to FIG. 15, an adjustable mount 10 is shown attached to an upstanding tree 14. The adjustable mount 10 does not have a protective cage 114 attached to it. Instead of a camera, a video camera is attached to the support structure 62 of the adjustable mount 10. A specially design U-shaped bracket 122 is secured between the support structure 62 and the video camera 120 to make it easy to secure the video camera to the support structure 62. The bracket 122 is optional and one skilled in the art can use whatever type of bracket 122 best suits their intended needs.

Lastly, it should be understood that any camera, especially light weight, versatile, compact and/or universal game cameras can be mounted to the adjustable mount 10. In fact, one may be able to secure two or more pieces of equipment 12 to the adjustable mount 10 at one time, especially if the equipment is relatively small.

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications and variations which fall within the spirit and scope of the appended claims.

I claim:

1. An adjustable mount for securing a piece of equipment 12 to another member, comprising:
a) a first member attachable to said another member;
b) an elongated member having a first end and a second end, said first end secured to said first member;
c) a sphere attached to said second end of said elongated member;
d) a pair of plates aligned parallel to one another and spaced apart by a set distance, each of said pair of plates having an aperture formed therein which is sized to mate with a portion of said sphere, and said pair of plates capable of rotating and pivoting on said sphere;
e) a support structure secured to said pair of plates, said support structure capable of having said piece of equipment 12 attached thereto; and
f) an adjustment mechanism positioned between said pair of plates which is capable of changing said set distance, said adjustment mechanism capable of rotating in a first direction to lock said pair of plates to said sphere and rotating in an opposite direction to unlock said pair of plates from said sphere.

2. The adjustable mount of claim 1 wherein said another member is a tree and said first member is secured to said tree by a strap.

3. The adjustable mount of claim 2 wherein said first member is secured to said tree by a threaded screw having a first end with a sharp point and an opposite, second end having an enlarged head.

4. The adjustable mount of claim 1 wherein said pair of plates can rotate in a first plane over a range of from about 1 degree to about 200 degrees and can pivot in a second plane aligned at an acute angle to said first plane.

5. The adjustable mount of claim 4 wherein said second plane is aligned perpendicular to said first plane, and pair of plates can pivot over a range of from 1 degree to about 60 degrees in said second plane.

6. The adjustable mount of claim 1 wherein said sphere is formed of hard rubber.

7. The adjustable mount of claim 1 wherein each of said apertures extends through one of said pair of plates and said apertures are coaxially aligned with one another.

8. The adjustable mount of claim 7 wherein each of said apertures has a serrated inner periphery.

9. The adjustable mount of claim 8 wherein said serrated inner periphery contains a plurality of tooth-like projections each separated by a notch.

10. An adjustable mount for securing a photographic device to an upstanding member, comprising:
a) a first member attachable to said upstanding member;
b) a stem having a first end and a second end, said first end secured to said first member;
c) a sphere attached to said second end of said stem;
d) a pair of plates aligned parallel to one another and spaced apart by a set distance, each of said pair of plates having an aperture formed therethrough and each having a serrated inner periphery, each of said serrated inner peripheries sized to mate with a portion of said sphere, and said pair of plates capable of rotating and pivoting on said sphere;
e) a support structure secured to said pair of plates, said support structure capable of having said photographic device attached thereto; and
f) an adjustment mechanism positioned between said pair of plates which is capable of changing said set distance, said adjustment mechanism capable of rotating in a first direction to lock said pair of plates to said sphere and rotating in an opposite direction to unlock said pair of plates from said sphere.

11. The adjustable mount of claim 10 wherein each of said serrated inner peripheries contains a plurality of tooth-like projections arranged at least 45 degrees apart from one another.

12. The adjustable mount of claim 11 wherein at least three tooth-like projections are formed on each of said inner peripheries.

13. The adjustable mount of claim 11 wherein said sphere has a diameter of at least 1 inch and is constructed of a hard material.

14. The adjustable mount of claim 13 wherein each of said apertures has a diameter which is less than said diameter of said sphere.

15. The adjustable mount of claim 10 wherein said support structure has an outer periphery which is larger than said photographic device and a metal cage is attachable to said support structure to completely enclose and protect said photographic device.

16. An adjustable mount for securing a camera in a desired position relative to a stationary member, comprising:
a) a first member having at least two elongated, spaced apart legs, each of said legs having a sharp distal end;
b) at least one fastener sized to secure said first member to said stationary member such that when said fastener is tightened, said sharp distal ends of said legs will contact said stationary member;
c) a stem having a first end and a second end, said first end secured to said first member;
c) a sphere attached to said second end of said first bracket;
d) a pair of plates aligned parallel to one another and spaced apart by a set distance, each of said plates having an aperture formed therethrough and each having a serrated inner periphery, and each of said serrated inner peripheries being sized to mate with a portion of said sphere, and said pair of plates capable of rotating and pivoting on said sphere;
e) a support structure secured to said pair of plates, said support structure capable of having said camera attached thereto; and
f) a threaded adjustment mechanism positioned between said pair of plates which is capable of changing said set distance, said threaded adjustment mechanism capable of rotating in a first direction to lock said pair of plates to said sphere and rotating in an opposite direction to unlock said pair of plates from said sphere.

17. The adjustable mount of claim 16 wherein said first member, said stem, said pair of plates, and said support structure are powder coated to prevent rusting.

18. The adjustable mount of claim 16 wherein said camera has an outer periphery, and said support structure has an outer periphery which is larger than said outer periphery of said camera, and a protective cage is removably attached to said support structure to completely enclose and protect said camera.

19. The adjustable mount of claim 16 wherein said pair of plates can rotate in a first plane over a range of from about 1 degree to about 200 degrees and said pair of plates can pivot in a second plane, which is aligned at an acute angle to said first plane, over a range of from about 1 degree to about 60 degrees.

20. The adjustable mount of claim 16 wherein each of said pair of plates has an L-shaped profile, each L-shaped profile including a first section which is longer than a second section, said aperture being formed in said first section and said second section being secured to said support structure, and said apertures formed in each of said pair of plates are coaxially aligned relative to one another when said pair of plates are in contact with said sphere.
